(19) United States
(12) Patent Application Publication
(10) Pub. No.: US 2019/0128414 A1
(43) Pub. Date: May 2, 2019

(54) CONTROL SYSTEM FOR A CONTINUOUSLY VARIABLE TRANSMISSION IN A VEHICLE PROPULSION SYSTEM

(71) Applicant: GM GLOBAL TECHNOLOGY OPERATIONS LLC, DETROIT, MI (US)

(72) Inventors: Virinchi Mallela, Novi, MI (US); Douglas A. Ward, Holly, MI (US); Paul G. Otanez, Franklin, MI (US); Bret M. Olson, White Lake, MI (US); Ronald W. Van Diepen, Ann Arbor, MI (US)

(21) Appl. No.: 15/796,889

(22) Filed: Oct. 30, 2017

(51) Int. Cl. F16H 61/662; F16H 9/18

(52) U.S. Cl. CPC F16H 61/66272; F16H 2059/147; F16H 2061/66277; F16H 9/18

(57) ABSTRACT

A continuously variable transmission for a vehicle propulsion system includes a controller including an instruction set, the instruction set executable to determine whether a current inertia torque value is greater than a previous inertia torque value, execute control over one of a first clamp pressure and a second clamp pressure such that one of the first clamp pressure and the second clamp pressure corresponds to a current inertia torque value if the current inertia torque value is greater than a previous inertia torque value, and execute control over one of the first clamp pressure and the second clamp pressure such that said one of the first clamp pressure and the second clamp pressure corresponds to previous inertia torque value if the current inertia torque value is not greater than a previous inertia torque value for a predetermined period of time.

### FIELD

The present disclosure relates to a control system for a continuously variable transmission in a vehicle propulsion system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Vehicle propulsion systems having a prime mover, such as, for example, an internal combustion engine, an electric motor and/or the like, coupled to a continuously or infinitely variable transmission (CVT) may be employed to provide tractive effort in vehicles. A CVT is capable of continuously changing an input/output speed ratio over a range between a minimum (underdrive) ratio and a maximum (overdrive) ratio, thus permitting infinitely variable selection of engine operation that achieves a preferred balance of fuel consumption and engine performance in response to an operator torque request.

Known chain-type continuously variable transmissions may include two pulleys, each having two sheaves. A chain or belt may run between the two pulleys, with the two sheaves of each of the pulleys sandwiching the chain between them. Frictional engagement between the sheaves of each pulley and the chain couples the chain to each of the pulleys to transfer torque from one pulley to the other. One of the pulleys may operate as a drive or input pulley, and the other pulley may operate as a driven or output pulley. The gear ratio (also known as a speed ratio) is the ratio of the torque of the driven pulley to the torque of the drive pulley. The gear ratio may be changed by urging the two sheaves of one of the pulleys closer together and urging the two sheaves of the other pulley farther apart from each other, causing the chain to ride higher or lower on the respective pulley. The gear/speed ratio may also be obtained by dividing a transmission input rotation speed by a transmission output rotation speed. The target gear/speed ratio may be determined based upon a number of factors including, for example, the driver pedal input, the vehicle speed and the like, without limitation.

Inertia torque is a torque that results from a rotational acceleration of components in the vehicle propulsion system. The amount of inertia torque may be calculated from the rotational acceleration, which may be derived from various rotational speed sensor signals, and the moment of inertia of each corresponding mass within the driveline. If the speed ratio changes with a speed change, the rotation speed of the engine will change and an inertia torque may increase. The amount of torque which is actually available to propel the vehicle is roughly based upon the engine torque minus the inertia torque. U.S. Pat. Nos. 6,625,531 and 8,088,036, which are incorporated herein in their entirety, disclose exemplary methods for adjusting the operation of a CVT, such as, for example a clamp torque and/or ratio, and the overall vehicle propulsion system, based upon the effect of inertia torque. In particular, a vehicle propulsion system may be controlled using a torque control type of system in which the controlled operating characteristics of the CVT may be more accurately adapted to the actual amount of torque to be transmitted by the CVT while taking inertia torque into consideration. It is valuable to control the CVT based upon knowledge of the inertia torque because if the clamping force in the CVT is not sufficient it may be possible to slip the chain. Therefore, to avoid this, the CVT may be controlled such that it accounts for the inertia torque. Additionally, a clamping torque corresponds to the desired minimum torque capacity for the CVT to transfer torque smoothly without slipping the chain. It is calculated using engine torque and inertia torque while taking into consideration any losses in the system.

### SUMMARY

In an exemplary aspect, a vehicle propulsion system includes a prime mover coupled to a torque transmitting shaft, a continuously variable transmission that includes a torque input shaft coupled to the torque transmitting shaft, a first pulley coupled to the torque input shaft, a flexible continuous rotatable device coupled to the first pulley and to a second pulley, the first pulley including a first moveable sheave that is translated along a first axis relative to a first stationary sheave in response to a first clamp pressure applied to a first actuator, the second pulley including a second moveable sheave that is translated along a second axis relative to a second stationary sheave in response to a second clamp pressure applied to a second actuator, and a controller including an instruction set, the instruction set executable to determine whether a current inertia torque value is greater than a previous inertia torque value, execute control over one of the first clamp pressure and the second clamp pressure such that said one of the first clamp pressure and the second clamp pressure corresponds to current inertia torque value if the current inertia torque value is greater than a previous inertia torque value, and execute control over one of the first clamp pressure and the second clamp pressure such that said one of the first clamp pressure and the second clamp pressure corresponds to previous inertia torque value if the current inertia torque value is not greater than a previous inertia torque value for a predetermined period of time.

In this manner, oscillations in a vehicle propulsion system having a continuously variable transmission may be reduced and/or eliminated which may significantly improve the experience of occupants of the vehicle. Further, by reducing or eliminating the oscillations, the cycling of components within the continuously variable transmission in response to those oscillations may be reduced which may thereby improve reliability and durability of those components. Additionally, the reduction in response by the components of the continuously variable transmission may correspondingly reduce the amount of energy which would otherwise have been consumed in the unnecessary and undesirable operation of those components, thereby improving the fuel efficiency, economy, and performance of a vehicle propulsion system incorporating the continuously variable transmission.

In another exemplary embodiment, the system further includes instructions in the instruction set executable to execute control over one of the first clamp pressure and the second clamp pressure such that said one of the first clamp pressure and the second clamp pressure ramps downwardly from the previous inertia torque at a predetermined ramp rate.

In another exemplary embodiment, the predetermined period of time is greater than about one half of a period of a natural resonance frequency of the vehicle propulsion system.

In another exemplary embodiment, the system further includes instructions in the instruction set executable to determine a frequency component in a rotational oscillation of the vehicle propulsion set, and wherein the predetermined period of time is greater than about one half of a period of the determined frequency component.

In another exemplary embodiment, the system further includes a driver pedal position sensor generating a pedal position signal indicating a position of a driver pedal, wherein the controller executes control over one of the first clamp pressure and the second clamp pressure such that said one of the first clamp pressure and the second clamp pressure corresponds to previous inertia torque value if the current inertia torque value is not greater than a previous inertia torque value for a predetermined period of time, if the pedal position signal indicates a pedal position less than a predetermined pedal position, and a torque from the prime mover is less than zero.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 schematically illustrates elements of a vehicle propulsion system 100 that includes a prime mover 110 rotatably coupled to a continuously variable transmission (CVT);

FIG. 2 schematically illustrates elements of a chain-type continuously variable transmission (CVT);

FIG. 3 illustrates signals from an exemplary vehicle propulsion system which includes a continuously variable transmission (CVT);

FIG. 4 is a graph illustrating a method for disassociating a continuously variable transmission (CVT) from an oscillating torque in accordance with an exemplary embodiment of the present disclosure;

FIG. 5 is a graph 500 illustrating the significant advantages of the exemplary control system and method in accordance with the present disclosure; and

FIG. 6 illustrates a flowchart 600 of an exemplary method for a CVT controller for a vehicle propulsion system in accordance with the present disclosure.

In the drawings, reference numbers may be reused to identify similar and/or identical elements.

### DETAILED DESCRIPTION

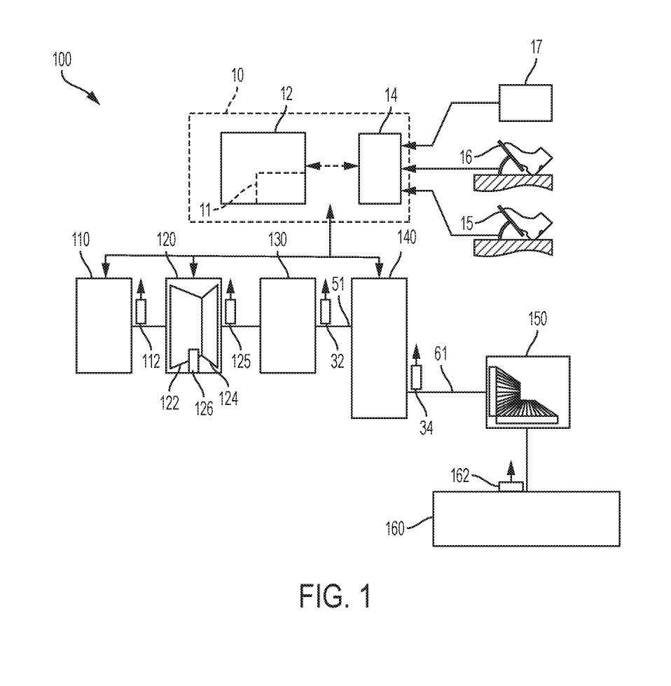

Referring now to the drawings, wherein the depictions are for the purpose of illustrating certain exemplary embodiments only and not for the purpose of limiting the same, FIG. 1 schematically illustrates elements of a vehicle propulsion system 100 that includes a prime mover 110 rotatably coupled to a continuously variable transmission (CVT) 140 via a torque converter 120 and a gear box 130. The vehicle propulsion system 100 couples via a driveline 150 to a vehicle wheel 160 to provide tractive effort when employed on a vehicle. Operation of the vehicle propulsion system 100 is monitored by and controlled by a controller 10 in response to driver commands and other factors.

The prime mover 110 may be, for example, an internal combustion engine, a motor, or any other system without limitation that is capable of generating torque in response to commands originating from the controller 10. The torque converter 120 may provide a fluid coupling between its input and output members for transferring torque, and preferably may include a pump 122 that is coupled to the prime mover 110, a turbine 124 that is coupled via the output member to the gear box 130 and a torque converter clutch 126 that locks rotation of the pump 122 and turbine 124 and is controllable by the control system 10. The output member of the torque converter 120 rotatably couples to the gear box 130, which may include meshed gears or other suitable gearing mechanisms that provide reduction gearing between the torque converter 120 and the CVT 140. Alternatively, the gear box 130 may be another suitable gear configuration for providing gearing between the engine 110, the torque converter 120 and the CVT 140, including, by way of non-limiting examples, a chain drive gear configuration or a planetary gear configuration. In alternative embodiments, either or both the torque converter 120 and the gear box 130 may be omitted.

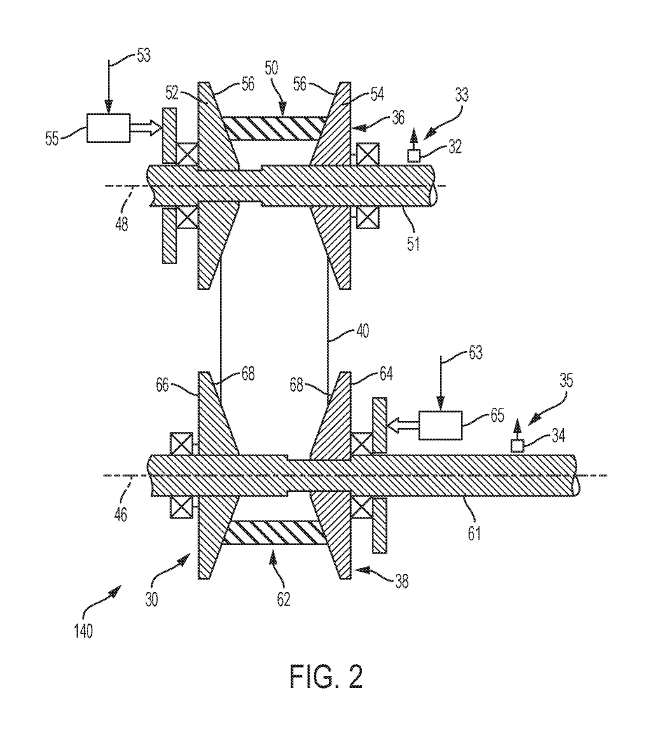

The gear box 130 may include an output member that rotatably couples to the CVT 140 via an input member 51. One exemplary embodiment of the CVT 140 is described with reference to FIG. 2. An output member 61 of the CVT 140 rotatably couples to the driveline 150, which rotatably couples to the vehicle wheels 160 via an axle, half-shaft or another suitable torque transfer element. The driveline 150 may include a differential gearset, a chain drive gearset or another suitable gear arrangement for transferring torque to one or more vehicle wheels 160.

The vehicle propulsion system 100 preferably includes one or more sensing devices for monitoring rotational speeds of various devices, including, e.g., an engine speed sensor 112, a torque converter turbine speed sensor 125, a CVT input speed sensor 32, a CVT output speed sensor 34, and a wheel speed sensor 162, through which vehicle speed (Vss) may be monitored. Each of the aforementioned speed sensors may be any suitable rotation position/speed sensing device, such as, for example, a Hall-effect sensor. Each of the aforementioned speed sensors communicates with the controller 10.

The controller 10 preferably includes one or a plurality of controllers 12 and a user interface 14. A single controller 12 is shown for ease of illustration. The controller 12 may include a plurality of controller devices, wherein each of the controllers 12 is associated with monitoring and controlling a single system. This may include an engine control module (ECM) for controlling the engine 110, and a transmission controller (TCM) for controlling the CVT 140 and monitoring and controlling a single subsystem, e.g., a torque converter clutch. The controller 12 preferably includes a memory device 11 containing executable instruction sets. The user interface 14 communicates with operator input devices including, e.g., an accelerator pedal 15, a brake pedal 16 and a transmission gear selector 17.

FIG. 2 schematically illustrates elements of a chain-type continuously variable transmission (CVT) 140 that is advantageously controlled by a controller 12. A variator 30 transfers torque between the first rotating member 51 and the second rotating member 61. The first rotating member 51 may be referred to as an input member 51, and the second rotating member 61 may be referred to as an output member 61.

The variator 30 includes a first, or primary pulley 36, a second, or secondary pulley 38 and flexible continuous rotatable device 40 that rotatably couples the first and second pulleys 36, 38 to transfer torque between them. The first pulley 36 rotatably attaches to the input member 51 and the second pulley 38 rotatably attaches to the output member 61, and the rotatable device 40 is adapted to transfer torque between the first and second pulleys 36, 38 and thus between the input and output members 51, 61. The first pulley 36 and input member 51 rotate about a first axis 48, and the second pulley 38 and output member 61 rotate about a second axis 46. The continuous rotatable device 40 may be a belt, a chain, or another suitable flexible continuous device, without limitation.

The first pulley 36 is split perpendicular to the first axis 48 to define an annular first groove 50 that is formed between a moveable sheave 52 and a stationary sheave 54. The moveable sheave 52 axially moves or translates along the first axis 48 relative to the stationary sheave 54. For example, the moveable first sheave 52 may be attached to the input member 51 via a splined connection, thereby allowing axial movement of the moveable first sheave 52 along the first axis 48. The stationary first sheave 54 is disposed opposite the moveable first sheave 52. The stationary first sheave 54 is axially fixed to the input member 51 along the first axis 48. As such, the stationary first sheave 54 does not move in the axial direction of the first axis 48. The moveable first sheave 52 and the stationary first sheave 54 each include a first groove surface 56. The first groove surfaces 56 of the moveable first sheave 52 and the stationary first sheave 54 are disposed opposite each other to define the annular first groove 50. The opposed first grooved surfaces 56 preferably form an inverted frusto-conical shape such that a movement of the moveable first sheave 52 towards the stationary first sheave 54 increases an outer pulley diameter of the annular first groove 50. An actuator 55 is arranged with the first pulley 36 to control an axial position of the moveable first sheave 52 in response to a drive signal 53, including urging the moveable first sheave 52 towards the stationary first sheave 54. In one embodiment, the actuator 55 is a hydraulically-controlled device and the drive signal 53 is a hydraulic pressure signal.

The second pulley 38 is split perpendicular to the second axis 46 to define an annular second groove 62. The annular second groove 62 is disposed perpendicular to the second axis 46. The second pulley 38 includes a moveable sheave 64 and a stationary sheave 66. The moveable sheave 64 axially moves or translates along the second axis 46 relative to the stationary sheave 66. For example, the moveable second sheave 64 may be attached to the output member 61 via a splined connection, thereby allowing axial movement of the moveable second sheave 64 along the second axis 46. The stationary second sheave 66 is disposed opposite the moveable second sheave 64. The stationary second sheave 66 is axially fixed to the output member 61 along the second axis 46. As such, the stationary second sheave 66 does not move in the axial direction of the second axis 46. The moveable second sheave 64 and the stationary second sheave 66 each include a second groove surface 68. The second groove surfaces 68 of the moveable second sheave 64 and the stationary second sheave 66 are disposed opposite each other to define the annular second groove 62. The opposed second grooved surfaces 68 preferably form an inverted frusto-conical shape such that a movement of the moveable second sheave 64 towards the stationary second sheave 66 increases an outer pulley diameter of the annular second groove 62. An actuator 65 is arranged with the second pulley 38 to control an axial position of the moveable second sheave 64 in response to a driven signal 63, including urging the moveable second sheave 64 towards the stationary second sheave 66. In one embodiment, the actuator 65 is a hydraulically-controlled device and the driven signal 63 is a hydraulic pressure signal. A ratio of the outer pulley diameter of the first pulley 36 and the outer pulley diameter of the second pulley 38 defines a gear/speed ratio. Other elements, such as clutch assemblies in the form of selectable one-way clutches and the like may be deployed between the variator 30 and other vehicle propulsion system and driveline components and systems.

Various sensors are suitably positioned for sensing and providing signals related to operation of the CVT 140, including the CVT input speed sensor 32 and the CVT output speed sensor 34. The input speed sensor 32 may be mounted near the input member 51 to generate an input speed signal 33, and the CVT output speed sensor 34 may be mounted near the output member 61 to generate an output speed signal 35.

The variator speed ratio (VSR) is a ratio of the speed of the output member 61 in relation to the speed of the input member 51. Forms of the VSR may be employed as a control parameter for the CVT 140, including an actual VSR and a desired VSR. The actual VSR indicates a present, measured value for the VSR, and may be determined based upon a ratio of the input speed signal 33 and the output speed signal 35. The desired VSR indicates a commanded, future value for the VSR, which may be determined based upon monitored and estimated operating conditions related to an output power command, vehicle speed and engine torque. The controller 12 controls the CVT 140 to achieve the desired VSR by controlling pressures of one or both the primary pulley 36 and the secondary pulley 38 of the CVT 140. Controlling pressures of one or both the primary pulley 36 and the secondary pulley 38 of the CVT 140 can be achieved by controlling the drive and driven signals 53, 63 to apply requisite pressures to the first and second actuators 55, 65 to effect the desired VSR, wherein the requisite pressures are preferably in the form of a primary pressure command and a secondary pressure command.

CVT control systems may adapt pulley clamping pressures such that they are sufficient to ensure that the belt does not slip on the pulleys. Belt or chain slip in a CVT may adversely affect the reliability and durability of the CVT. Clamping pressures may be determined based upon the torque capacity of the CVT. In general, the higher the torque required to be transmitted by the CVT the higher the clamping pressure is required to transmit the torque while preventing belt slip. However, higher clamping pressures also tend to reduce the efficiency of the CVT. A balance between the potential efficiency of lower clamping pressures and the torque carrying capacity of higher clamping pressures may be critical for advantageous operation of a CVT in a vehicle propulsion system. Therefore, CVT control systems for a vehicle propulsion system may monitor and closely control clamping pressures to ensure that they maintain a clamping pressure which is sufficient to carry a required amount of torque, including an inertia torque, but not too high as to adversely affect efficiency

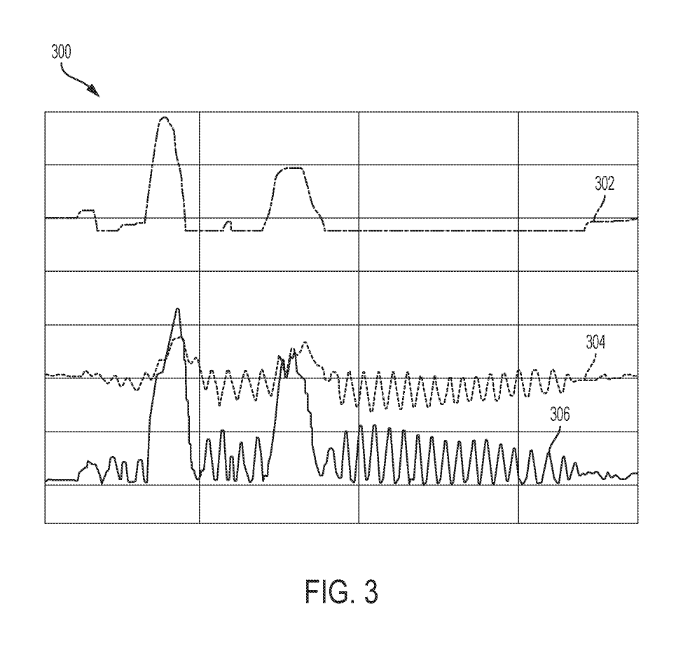

One problem with these systems is illustrated with reference to the graph 300 of FIG. 3 which includes signals from an exemplary vehicle propulsion system which includes a CVT. A driver pedal signal 302 may correspond to a signal received from a driver throttle pedal. Line 304 represents the rotational speed of a transmission output shaft and line 306 represents the pulley clamp torque for the CVT. As is clearly illustrated by FIG. 3, the speed of the transmission output shaft 304 is oscillating. This oscillation may originate from any number of different sources, such as, for example, prime mover input torque, road disturbances and the like, without limitation. As explained above, the operating characteristic of the CVT may be controlled in response to an inertia torque. That inertia torque may be calculated based upon an oscillating driveline rotational speed, such as, in this example, the oscillating transmission output shaft speed signal 304, which then may result in the clamping torque 306 oscillating in response. Additionally, the oscillating response of the clamping torque 306 may only serve to further excite the driveline oscillations. Alternatively, the ratio of the CVT may be responsive to the oscillating inertia torque.

Further, should one or more modes of an excitation frequency correspond to or be in phase with one or modes of the natural frequency of the driveline, then these oscillations may not dampen and may continue to perpetuate and, in some instances, further amplify. These oscillations may adversely affect the experience of occupants of the vehicle. In some instances, these oscillations may be felt by occupants as a type of rocking and/or vibration which is undesirable.

Further, the corresponding oscillations in the commanded operation of the CVT may adversely affect the reliability and durability of the CVT as well as other components of the vehicle propulsion system. Additionally, these oscillations and the reactions to those oscillations within the vehicle propulsion system consume energy which may adversely affect the fuel economy, efficiency and performance of the vehicle propulsion system.

Previous attempts at addressing this problem may have relied upon filtering such as, for example, applying a notch and/or lag filter. However, these attempted solutions have suffered from slow response times and large computational workloads for the controller. Other attempts may have relied upon adapting the CVT control system using weights, biases, and/or other values which may have been obtained through a calibration procedure. For example, a calibration procedure may determine an offset which then may result in the CVT clamp torque substantially ignoring the inertia torque. These types of methods may require significant calibration work to be performed to determine those values.

In contrast, to conventional CVT control systems for vehicle propulsion systems which may always closely react to and follow an oscillating torque (including an inertia torque), the inventors discovered that they could prevent the pulley clamp torque from reacting to these oscillations and prevent the CVT from further exciting the vehicle driveline oscillations by temporarily disassociating the pulley clamp torque of the CVT from the inertia torque associated with the oscillating driveline. Further, in an exemplary embodiment the CVT control system for a vehicle propulsion system in accordance with the present disclosure is highly responsive and provides a clamp torque which either follows an amount which may have been calculated to be sufficient to compensate for an inertia torque when that inertia torque is increasing or exceeds that amount when the inertia torque is decreasing.

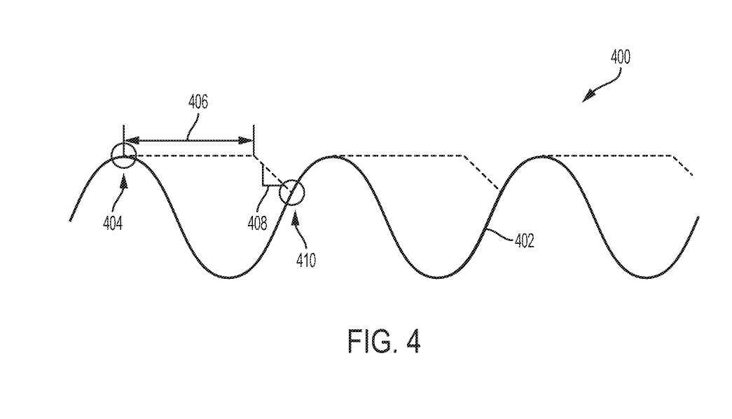

Referring now to the graph 400 of FIG. 4, one exemplary system and method for temporarily disassociating the CVT from the oscillating inertia torque may be described. The oscillating inertia torque signal is illustrated as line 402. In the exemplary CVT control system, the clamp torque initially follows the inertia torque signal 402 as it increases and approaches a first peak at 404. When the control system determines that the inertia torque has reached a peak, then the control system causes the clamp torque to hold at the value that it reached when it arrived at the peak. The control system then holds that clamp torque value for a period of time 406. When the period of time 406 elapses, then the control system permits the clamp torque to ramp down at a predetermined rate 408. As the clamp torque proceeds down the ramp at the predetermined rate 408, the inertia torque signal 402 may again increase and when it reaches a point 410 where the clamp torque reaches a value that corresponds to the increasing inertia torque signal 402, then the control system causes the clamp torque to again follow the inertia torque signal 402. This process may repeat, as necessary, for each oscillation in an oscillating driveline.

The length of the predetermined period of time (or hold time) 406 may be selected in any manner without limitation. In an exemplary embodiment, the hold time may be predetermined such that it may be larger the known period of a natural frequency of the driveline that may have been directly measured in a calibration process. Alternatively, the control system may rely upon the sensed signals to directly measure the oscillations, perform a Fast Fourier Transform on that oscillating signal to determine the primary or dominant frequency in real time and then calculate the hold time, in real time, such that it is sufficient to exceed the period of that frequency.

The ramp rate may also be predetermined using calibration processes. In a preferred embodiment, the ramp rate may depend upon the pressure/hydraulic characteristics of the CVT. If the ramp is too quick, the clamping pressure may undershoot a desired clamp pressure. In general, it is preferable that the ramp rate should be slower than the responsiveness of the hydraulic/pressure characteristics of the CVT.

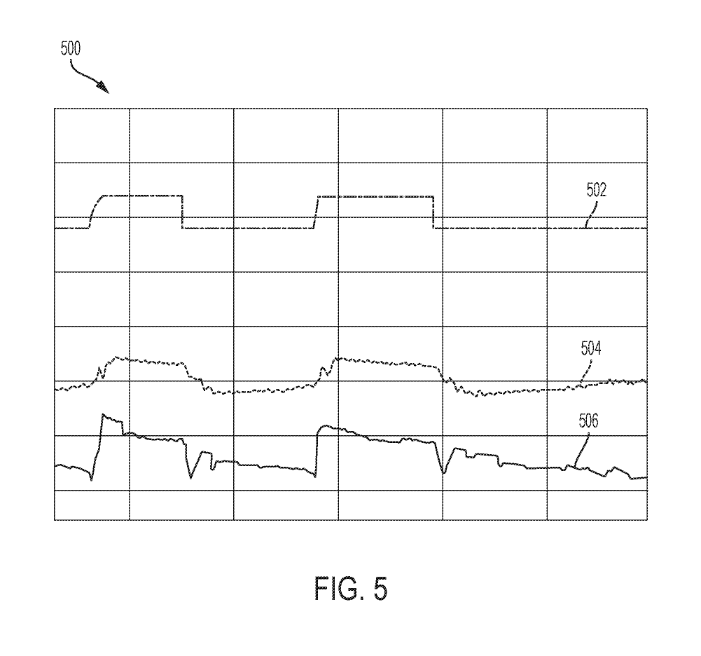

FIG. 5 is a graph 500 illustrating the signals which are similar to those illustrated by FIG. 3, however, the system which generated the graph 500 of FIG. 5 illustrates the significant advantages of the exemplary control system and method in accordance with the present disclosure. A driver pedal signal 502 corresponds to a signal received from a driver pedal, line 504 represents the rotational speed of the transmission output shaft, and line 506 represents the pulley clamp torque that is commanded by the exemplary control system and method. As is clearly seen, and in stark contrast to FIG. 3, the oscillations in the vehicle propulsion system have been substantially reduced. In this manner, any oscillations in the driveline of the vehicle propulsion system are not perpetuated by a clamping torque of a CVT following along with those oscillations. To the contrary, the clamping torque is periodically and temporarily disassociated from the oscillations by holding a peak value for a predetermined period of time in accordance with an exemplary embodiment of the present disclosure.

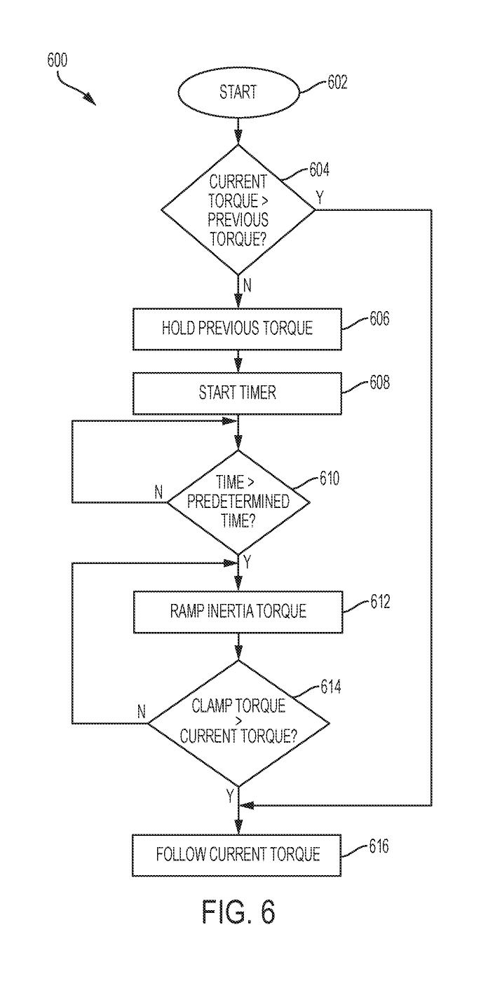

FIG. 6 illustrates a flowchart 600 of an exemplary method for a CVT controller for a vehicle propulsion system in accordance with the present disclosure. The method starts at step 602 and continues to step 604. In step 604, the controller determines whether the clamp torque based on current inertia is greater than the clamp torque based on previous inertia torque. If in step 604, the controller determines that the clamp torque based on current inertia is not greater than the clamp torque based on previous inertia torque then the method continues to step 606. In step 606, the controller maintains or holds the previous value for inertia torque and controls the clamp torque of the CVT based upon that previous value for inertia torque and then continues to step 608. In step 608, the controller starts a timer and continues to step 610. In step 610, the controller determines whether the amount of time which has elapsed is greater than a predetermined hold time. If, in step 610, the controller determines that the amount of time which has elapsed is not greater than a predetermined hold time, then the controller loops back to step 610. If, however, in step 610, the controller determines that the amount of time which has elapsed is greater than the predetermined hold time then the method continues to step 612. In step 612, the controller initiates a ramp of the inertia torque and continues to step 614. In step 614, the controller determines whether the clamp torque based on the current inertia is greater than the clamp torque based on the ramped value of the inertia torque. If, in step 614, the controller determines the clamp torque based on the current inertia is greater than the clamp torque based on the ramped value of the inertia torque then the method continues to step 616. In step 616, the controller resets the timer and controls the clamp torque such that it follows the current inertia torque and the method then returns to step 604. If, however, in step 614, the controller determines the clamp torque based on the current inertia is not greater than the clamp torque based on the ramped value of the inertia torque then the method returns to step 612.

In this manner, the CVT control system for a vehicle propulsion system may control the CVT clamp torque based upon an absolute value of a torque signal. Alternatively, in another exemplary CVT control system for a vehicle propulsion system may adapt to engine torque signals which may potentially have negative values. It is understood that the CVT clamp torque cannot be a negative value, therefore, operating the clamp torque based upon absolute values may simplify the operation as in the flowchart of FIG. 6. The difference between an absolute method/system and a signed method/system is that the signed method/system may contemplate when the inertia torque is negative such as when, for example, a driver lifts off the accelerator pedal and the engine acts as a load on the driveline. In that situation, the engine torque is negative and the inertia torque may also be negative and, therefore, they would add together, however, the CVT controller may be holding a positive peak when there is a negative engine torque which counteracts the inertia torque and result in a lower clamp torque. So, instead, in that situation an exemplary CVT control system may let go of the peak and hold and instead follow the negative torque value.

It is to be further understood that while the present disclosure generically refers to an inertia torque, that inertia torque may be based upon any number of different inertia torque values which may be calculated within a CVT control system for a vehicle propulsion system without limitation. For example, the inertia torque may correspond to an inertia torque signal which may be arbitrated, commanded, calculated, sensed, and/or the like without limitation.

In another exemplary embodiment, the CVT control system for a vehicle propulsion system may operate in accordance with a method which does not refer to a pedal position. This may be advantageous in applications and instances in which driveline oscillations may be present at low or zero driver pedal input.

In another exemplary embodiment, a CVT control system for a vehicle propulsion system in accordance with the present disclosure, may have different hold and ramp values which may be based upon, or vary in accordance with, the sign of torque values. The vehicle propulsion system may react differently and operate in accordance with a set of characteristics which may differ in accordance with different operating conditions.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle propulsion system, the system comprising:
a prime mover coupled to a torque transmitting shaft;
a continuously variable transmission that includes a torque input shaft coupled to the torque transmitting shaft, a first pulley coupled to the torque input shaft, a flexible continuous rotatable device coupled to the first pulley and to a second pulley, the first pulley including a first moveable sheave that is translated along a first axis relative to a first stationary sheave in response to a first clamp pressure applied to a first actuator, the second pulley including a second moveable sheave that is translated along a second axis relative to a second stationary sheave in response to a second clamp pressure applied to a second actuator;
a torque output shaft coupled to the second pulley and to a final drive of the vehicle propulsion system;
a controller including an instruction set, the instruction set executable to:
determine whether a current inertia torque value is greater than a previous inertia torque value;
execute control over one of the first clamp pressure and the second clamp pressure such that said one of the first clamp pressure and the second clamp pressure corresponds to current inertia torque value if the current inertia torque value is greater than a previous inertia torque value; and
execute control over one of the first clamp pressure and the second clamp pressure such that said one of the first clamp pressure and the second clamp pressure corresponds to previous inertia torque value if the current inertia torque value is not greater than a previous inertia torque value for a predetermined period of time.

2. The system of claim 1, further comprising instructions in the instruction set executable to execute control over one of the first clamp pressure and the second clamp pressure such that said one of the first clamp pressure and the second clamp pressure ramps downwardly from the previous inertia torque at a predetermined ramp rate.

3. The system of claim 1, wherein the predetermined period of time is greater than a period of a natural resonance frequency of the vehicle propulsion system.

4. The system of claim 1, further comprising instructions in the instruction set executable to determine a frequency component in a rotational oscillation of the vehicle propulsion set, and wherein the predetermined period of time is greater than a period of the determined frequency component.

5. The system of claim 1, further comprising a driver pedal position sensor generating a pedal position signal indicating a position of a driver pedal, wherein the controller executes control over one of the first clamp pressure and the second clamp pressure such that said one of the first clamp pressure and the second clamp pressure corresponds to previous inertia torque value if the current inertia torque value is not greater than a previous inertia torque value for a predetermined period of time, if the pedal position signal indicates a pedal position less than a predetermined pedal position, and a torque from the prime mover is less than zero.

6. A continuously variable transmission for a vehicle propulsion system comprising:
a torque input shaft adapted to be coupled to the torque transmitting shaft of a prime mover in the vehicle propulsion system;
a first pulley coupled to the torque input shaft, the first pulley including a first moveable sheave that is translated along a first axis relative to a first stationary sheave in response to a first clamp pressure applied to a first actuator;
a second pulley coupled to a torque output shaft, the second pulley including a second moveable sheave that is translated along a second axis relative to a second stationary sheave in response to a second clamp pressure applied to a second actuator;
a flexible continuous rotatable device coupled to the first pulley and to the second pulley; and
a controller including an instruction set, the instruction set executable to:
determine whether a current inertia torque value is greater than a previous inertia torque value;
execute control over one of the first clamp pressure and the second clamp pressure such that said one of the first clamp pressure and the second clamp pressure corresponds to current inertia torque value if the current inertia torque value is greater than a previous inertia torque value; and
execute control over one of the first clamp pressure and the second clamp pressure such that said one of the first clamp pressure and the second clamp pressure corresponds to previous inertia torque value if the current inertia torque value is not greater than a previous inertia torque value for a predetermined period of time.

7. The system of claim 6, further comprising instructions in the instruction set executable to execute control over one of the first clamp pressure and the second clamp pressure such that said one of the first clamp pressure and the second clamp pressure ramps downwardly from the previous inertia torque at a predetermined ramp rate.

8. The system of claim 1, wherein the predetermined period of time is greater than a period of a natural resonance frequency of the vehicle propulsion system.

9. The system of claim 6, further comprising instructions in the instruction set executable to determine a frequency component in a rotational oscillation of the vehicle propulsion set, and wherein the predetermined period of time is greater than a period of the determined frequency component.

10. The system of claim 6, wherein the controller executes control over one of the first clamp pressure and the second clamp pressure such that said one of the first clamp pressure and the second clamp pressure corresponds to previous inertia torque value if the current inertia torque value is not greater than a previous inertia torque value for a predetermined period of time, if a pedal position signal indicates a pedal position less than a predetermined pedal position, and a torque from the prime mover is less than zero.

11. A method for controlling a vehicle propulsion system with a prime mover coupled to a torque transmitting shaft, a continuously variable transmission that includes a torque input shaft coupled to the torque transmitting shaft, a first pulley coupled to the torque input shaft, a flexible continuous rotatable device coupled to the first pulley and to a second pulley, the first pulley including a first moveable sheave that is translated along a first axis relative to a first stationary sheave in response to a first clamp pressure applied to a first actuator, the second pulley including a second moveable sheave that is translated along a second axis relative to a second stationary sheave in response to a second clamp pressure applied to a second actuator, and a torque output shaft coupled to the second pulley and to a final drive of the vehicle propulsion system, the method comprising:
determining whether a current inertia torque value is greater than a previous inertia torque value;
executing control over one of the first clamp pressure and the second clamp pressure such that said one of the first clamp pressure and the second clamp pressure corresponds to current inertia torque value if the current inertia torque value is greater than a previous inertia torque value; and
executing control over one of the first clamp pressure and the second clamp pressure such that said one of the first clamp pressure and the second clamp pressure corresponds to previous inertia torque value if the current inertia torque value is not greater than a previous inertia torque value for a predetermined period of time.

12. The method of claim 11, further comprising executing control over one of the first clamp pressure and the second clamp pressure such that said one of the first clamp pressure and the second clamp pressure ramps downwardly from the previous inertia torque at a predetermined ramp rate.

13. The method of claim 11, wherein the predetermined period of time is greater than about a period of a natural resonance frequency of the vehicle propulsion system.

14. The method of claim 11, further comprising determining a frequency component in a rotational oscillation of the vehicle propulsion set, and wherein the predetermined period of time is greater than a period of the determined frequency component.

15. The method of claim 11, further comprising executing control over one of the first clamp pressure and the second clamp pressure such that said one of the first clamp pressure and the second clamp pressure corresponds to previous inertia torque value if the current inertia torque value is not greater than a previous inertia torque value for a predetermined period of time, if a pedal position signal indicates a pedal position less than a predetermined pedal position, and a torque from the prime mover is less than zero.
